(19) United States
(12) Patent Application Publication
(10) Pub. No.: US 2025/0129925 A1
(43) Pub. Date: Apr. 24, 2025

(54) LIGHT ASSEMBLY

(71) Applicant: XTHOT LLC, Indianapolis, IN (US)

(72) Inventor: Christopher Michael TRESS, Indianapolis, IN (US)

(21) Appl. No.: 18/918,654

(22) Filed: Oct. 17, 2024

Related U.S. Application Data
(60) Provisional application No. 63/591,303, filed on Oct. 18, 2023.

(51) Int. Cl. F21V 23/06; F21S 8/00; F21V 17/06; F21V 19/00; F21V 21/088; F21V 23/00; F21Y 105/18; F21Y 115/10

(52) U.S. Cl. CPC F21V 23/06; F21S 8/03; F21V 17/06; F21V 19/003; F21V 21/088; F21V 23/002; F21Y 2105/18; F21Y 2115/10

(57) ABSTRACT

A light assembly may include a base comprising a first electrical connector configured to be connected to a first electrical wire, a light module removably attachable to the base and comprising a source of light, a first electrical terminal positioned on the base or the light module and formed in a circle, and a second electrical terminal positioned on the other of the base or the light module to contact the first electrical terminal when the light module is removably attached to the base.

### CROSS-REFERENCE TO RELATED APPLICATION

This application claims the benefit of U.S. Application No. 63/591,303, filed Oct. 18, 2023, the entire contents of which is incorporated herein by reference.

### BACKGROUND

The use of energy-efficient lighting in residential and commercial settings has expanded significantly because energy-efficient lighting can reduce energy consumption, and therefore cost. Furthermore, reduced energy consumption can lessen the environmental impact of the lighting.

A range of technologies exist for energy-efficient lighting, but light-emitting diode (LED) lighting has grown in prevalence. LED lighting uses significantly less energy than older technologies (e.g., incandescent lightbulbs) for comparable illumination. Other benefits include the ability to adjust brightness and/or color temperature of the light from LED lighting, long lifetime, and high output relative to size. These benefits, among others, are the reason that LED lighting has become so popular and can readily be found throughout homes and businesses to illuminate a variety of spaces.

Common installations for LED lighting include under cabinets or shelves to produce a dramatic downlighting effect with the source of the light visually obscured by the cabinetry or shelving. Such installations provide challenges in that electrical connections must be made through the cabinetry or shelving in the most inconspicuous way possible to maintain an appealing aesthetic. Furthermore, retrofitting such installations for lighting where it did not exist previously may be even more complex because of the need to run wiring. At the same time, it is desirable to standardize the components for such installations as much as possible to allow for low-cost mass production.

Existing LED lighting products fail to adequately address such challenges and often present new ones. For example, existing LED lighting products often come with large housings with the LED itself fixed to the housing. Thus, the LED itself may not be replaceable separately from the rest of the unit such that if the LED expires, the whole unit must be replaced. And replacing the whole lighting unit might entail removing it from the cabinetry or shelving to which it was mounted, which could also necessitate complex electrical work that must be completed safely. Also, the wiring arrangement may be difficult to connect upon initial installation, especially in the case of retrofitting, and there would also be difficulty to disconnect and reconnect with a new unit in the event of an LED failure. Additionally, achieving adjustability of brightness and/or color temperature may require more complex circuitry in the unit, which in turn mandates a larger overall assembly.

### SUMMARY OF THE PRESENT TECHNOLOGY

One aspect of the present technology is to provide a light assembly that overcomes one or more of the shortcomings of the prior art, e.g., easy to install and wire in a broad range of installations, a light source (e.g., LEDs) that can be replaced without removing the entire lighting assembly in the case of LED failure or if a different type of LED is desired, and small assembly size to allow the broadest possible range of installation options.

An aspect of the present technology is a light assembly. The light assembly may comprise: a base; a light module removably attachable to the base and comprising a source of light; a first electrical terminal formed in a circle; and a second electrical terminal positioned to contact the first electrical terminal when the light module is removably attached to the base.

A further aspect of the present technology is a light assembly. The light assembly may comprise: a base comprising a first electrical connector configured to be connected to a first electrical wire; a light module removably attachable to the base and comprising a source of light; a first electrical terminal positioned on the base or the light module and formed in a circle; and a second electrical terminal positioned on the other of the base or the light module to contact the first electrical terminal when the light module is removably attached to the base.

In examples of the aspects of the two preceding paragraphs: (a) the first electrical terminal may be positioned on the base and the second electrical terminal may be positioned on the light module, (b) the first electrical terminal may be positioned on the light module and the second electrical terminal may be positioned on the base, (c) the light assembly may further comprise a plurality of first electrical terminals and a plurality of second electrical terminals, the plurality of first electrical terminals may be formed in concentric circles, each of the first electrical terminals having a different radius from others of the first electrical terminals, and each of the second electrical terminals may be positioned to contact a corresponding one of the first electrical terminals when the light module is removably attached to the base, (d) the plurality of first electrical terminals may comprise two, three, or four first electrical terminals and the plurality of second electrical terminals may comprise two, three, or four second electrical terminals, respectively, (e) each of the plurality of first electrical terminals may have a contact surface that is coplanar with the contact surface of others of the plurality of first electrical terminals, (f) the second electrical terminal may comprise a pogo pin that is biased to maintain contact with the first electrical terminal when the light module is removably attached to the base, (g) the light module may be freely rotatable relative to the base when the light module is removably connected to the base, (h) the first electrical connector may be a wire splicing connector configured to be electrically connected to the first electrical wire by push-in termination or lever actuation or the first electrical connector may be a USB-C connector, (i) the first electrical connector may be positioned on the base such that the first electrical wire extends from the base in a radial direction when connected to the first electrical connector, (j) the base may comprise a second electrical connector configured to be connected to a second electrical wire, (k) the second electrical connector may be a wire splicing connector configured to be electrically connected to the second electrical wire by push-in termination or lever actuation or the second electrical connector may be a USB-C connector, (l) the second electrical connector may be positioned on the base such that the second electrical wire extends from the base in a radial direction when connected to the second electrical connector, the source of light may be one or more light-emitting diodes (LEDs), (m) the base may comprise a first magnet and the light module may comprise a second magnet positioned and oriented on the light module to be magnetically attracted to the first magnet to removably attach the light module to the base, (n) a trim assembly may be removably attachable to the light module, the trim assembly may comprise a lens configured to be positioned over the source of light when the trim assembly is removably attached to the light module, and the trim assembly may comprise a trim piece positioned around the lens, (o) the trim piece may comprise first threads and the light module may comprise second threads, the first threads and the second threads being configured to be engaged to removably attach the light module to the trim piece, (p) one of the trim piece and the light module may comprise one or more ramped portions and the other of the trim piece and the light module may comprise one or more protruding portions corresponding to each of the ramped portions and configured to be engaged to corresponding ones of the ramped portions to removably attach the light module to the trim piece, (q) the trim piece may comprise a lip that extends radially outward around the trim piece, (r) the base may comprise one or more base holes, each of the base holes being configured to receive a fastener, (s) the light assembly may further comprise a clip having one or more clip holes that correspond to each of the base holes, the clip being configured to be secured to the base with the fastener at each pair of the base hole and the corresponding clip hole, the clip having one or more tangs, (t) the base may comprise a recessed portion, the first electrical connector being positioned in the recessed portion, and/or (u) one of the base and the light module includes a magnet and the other of the base and the light module includes a ferromagnetic material that is positioned and oriented to be attracted to the magnet to removably attach the light module to the base.

An aspect of the present technology is a light assembly. The light assembly may comprise: a base; a light module removably attachable to the base and comprising a source of light; a sender induction coil configured to generate an electromagnetic field; and a receiver induction coil configured to resonate in response to the electromagnetic field generated by the sender induction coil.

A further aspect of the present technology is a light assembly. The light assembly may comprise: a base comprising a first electrical connector configured to be connected to a first electrical wire; a light module removably attachable to the base and comprising a source of light; a sender induction coil positioned on the base and configured to generate an electromagnetic field; and a receiver induction coil positioned on the light module and configured to resonate in response to the electromagnetic field generated by the sender induction coil and produce electric current, when the light module is removably attached to the base and the sender induction coil is energized by electric current.

In examples of the aspects of the two preceding paragraphs: (a) the light module may be freely rotatable relative to the base when the light module is removably connected to the base, (b) the first electrical connector may be a wire splicing connector configured to be electrically connected to the first electrical wire by push-in termination or lever actuation or the first electrical connector may be a USB-C connector, (c) the first electrical connector may be positioned on the base such that the first electrical wire extends from the base in a radial direction when connected to the first electrical connector, (d) the base may comprise a second electrical connector configured to be connected to a second electrical wire, (e) the second electrical connector may be a wire splicing connector configured to be electrically connected to the second electrical wire by push-in termination or lever actuation or the second electrical connector may be a USB-C connector, (f) the second electrical connector may be positioned on the base such that the second electrical wire extends from the base in a radial direction when connected to the second electrical connector, (g) the source of light may be one or more light-emitting diodes (LEDs), (h) the base may comprise a first magnet and the light module may comprise a second magnet positioned and oriented on the light module to be magnetically attracted to the first magnet to removably attach the light module to the base, (i) a trim assembly may be removably attachable to the light module, the trim assembly may comprise a lens configured to be positioned over the source of light when the trim assembly is removably attached to the light module, and the trim assembly may comprise a trim piece positioned around the lens, (j) the trim piece may comprise first threads and the light module may comprise second threads, the first threads and the second threads being configured to be engaged to removably attach the light module to the trim piece, (k) one of the trim piece and the light module may comprise one or more ramped portions and the other of the trim piece and the light module may comprise one or more protruding portions corresponding to each of the ramped portions and configured to be engaged to corresponding ones of the ramped portions to removably attach the light module to the trim piece, (l) the trim piece may comprise a lip that extends radially outward around the trim piece, (m) the base may comprise one or more base holes, each of the base holes being configured to receive a fastener, (n) the light assembly may further comprise a clip having one or more clip holes that correspond to each of the base holes, the clip being configured to be secured to the base with the fastener at each pair of the base hole and the corresponding clip hole, the clip having one or more tangs, (o) the base may comprise a recessed portion, the first electrical connector being positioned in the recessed portion, and/or (p) one of the base and the light module may include a magnet and the other of the base and the light module may include a ferromagnetic material that is positioned and oriented to be attracted to the magnet to removably attach the light module to the base.

Of course, portions of the aspects may form sub-aspects of the present technology. Also, various ones of the sub-aspects and/or aspects may be combined in various manners and also constitute additional aspects or sub-aspects of the present technology.

Other aspects, features, and advantages of this technology will become apparent from the following detailed description when taken in conjunction with the accompanying drawings, which are a part of this disclosure and which illustrate, by way of example, principles of this technology.

### BRIEF DESCRIPTION OF THE DRAWINGS

FIG. 1A is a bottom perspective view of a light assembly according to an example of the present technology.

FIG. 1B is a top perspective view of a light assembly according to an example of the present technology.

FIG. 1C is a bottom plan view of a light assembly according to an example of the present technology.

FIG. 1D is a top plan view of a light assembly according to an example of the present technology.

FIG. 1E is an elevation view of a light assembly according to an example of the present technology.

FIG. 1F is another elevation view of a light assembly according to an example of the present technology.

FIG. 1G is an exploded view of a light assembly according to an example of the present technology.

FIG. 1H is a section view of a light assembly according to an example of the present technology taken through line 1H-1H of FIG. 1D.

FIG. 1I is an exploded view of a trim assembly according to an example of the present technology.

FIG. 2A is a bottom perspective view of a light module according to an example of the present technology.

FIG. 2B is a top perspective view of a light module according to an example of the present technology.

FIG. 2C is a bottom plan view of a light module according to an example of the present technology.

FIG. 2D is a top plan view of a light module according to an example of the present technology.

FIG. 2E is an elevation view of a light module according to an example of the present technology.

FIG. 2F is a section view of a light module according to an example of the present technology taken through line 2F-2F of FIG. 2C.

FIG. 3A is a bottom plan view of a trim piece for a light assembly according to an example of the present technology.

FIG. 3B is a top perspective view of a trim piece for a light assembly according to an example of the present technology.

FIG. 3C is an elevation view of a trim piece for a light assembly according to an example of the present technology.

FIG. 3D is a section view of a trim piece for a light assembly according to an example of the present technology taken through line 3D-3D of FIG. 3A.

FIG. 3E is a top plan view of a trim piece for a light assembly according to an example of the present technology.

FIG. 4A is a bottom perspective view of a light assembly according to an example of the present technology.

FIG. 4B is a top perspective view of a light assembly according to an example of the present technology.

FIG. 4C is a bottom plan view of a light assembly according to an example of the present technology.

FIG. 4D is a top plan view of a light assembly according to an example of the present technology.

FIG. 4E is an elevation view of a light assembly according to an example of the present technology.

FIG. 4F is another elevation view of a light assembly according to an example of the present technology.

FIG. 4G is an exploded view of a light assembly according to an example of the present technology.

FIG. 4H is a section view of a light assembly according to an example of the present technology taken through line 4H-4H of FIG. 4D.

FIG. 4I is an exploded view of a trim assembly according to an example of the present technology.

FIG. 5A is a bottom perspective view of a light module according to an example of the present technology.

FIG. 5B is a top perspective view of a light module according to an example of the present technology.

FIG. 5C is a bottom plan view of a light module according to an example of the present technology.

FIG. 5D is a top plan view of a light module according to an example of the present technology.

FIG. 5E is an elevation view of a light module according to an example of the present technology.

FIG. 5F is a section view of a light module according to an example of the present technology taken through line 5F-5F of FIG. 5C.

FIG. 6A is a bottom plan view of a trim piece for a light assembly according to an example of the present technology.

FIG. 6B is a top perspective view of a trim piece for a light assembly according to an example of the present technology.

FIG. 6C is an elevation view of a trim piece for a light assembly according to an example of the present technology.

FIG. 6D is a section view of a trim piece for a light assembly according to an example of the present technology taken through line 6D-6D of FIG. 6A.

FIG. 6E is a top plan view of a trim piece for a light assembly according to an example of the present technology.

FIG. 7A is a top perspective view of a base for a light assembly according to an example of the present technology.

FIG. 7B is a bottom perspective view of a base for a light assembly according to an example of the present technology.

FIG. 7C is a top plan view of a base for a light assembly according to an example of the present technology.

FIG. 7D is a bottom plan view of a base for a light assembly according to an example of the present technology.

FIG. 7E is an elevation view of a base for a light assembly according to an example of the present technology.

FIG. 7F is another elevation view of a base for a light assembly according to an example of the present technology.

FIG. 8A is a bottom perspective view of a base for a light assembly according to an example of the present technology.

FIG. 8B is a top perspective view of a base for a light assembly according to an example of the present technology.

FIG. 8C is another top perspective view of a base for a light assembly according to an example of the present technology.

FIG. 8D is a bottom plan view of a base for a light assembly according to an example of the present technology.

FIG. 8E is a top plan view of a base for a light assembly according to an example of the present technology.

FIG. 8F is an elevation view of a base for a light assembly according to an example of the present technology.

### DETAILED DESCRIPTION OF EXAMPLES OF THE PRESENT TECHNOLOGY

Before the present technology is described in further detail, it is to be understood that the technology is not limited to the particular examples described herein, which may vary. It is also to be understood that the terminology used in this disclosure is for the purpose of describing only the particular examples discussed herein, and is not intended to be limiting.

The following description is provided in relation to various examples which may share one or more common characteristics and/or features. It is to be understood that one or more features of any one example may be combinable with one or more features of another example or other examples. In addition, any single feature or combination of features in any of the examples may constitute a further

A light assembly 1 according to examples of the present technology, described in detail below, includes a base 10 and a light module 20 that is removably attachable to the base 10. The light module 20 may include a source of light 22, e.g., in the form of one or more light-emitting diodes (LEDs). The light module 20 may also include a reflector 26 to concentrate light from the source of light 22. The light module 20 may be freely rotatable 360° relative to the base 10 when removably attached thereto.

The light module 20 and the base 10 may be removably attached by magnetic attraction. The base 10 may have a magnet and the light module 20 may have another magnet that is positioned and oriented on the light module 20 to be magnetically attracted to the magnet of the base 10. Alternatively, one of the base 10 and the light module 20 may include a magnet and the other of the base 10 and the light module 20 may include a ferromagnetic material that is positioned and oriented to be attracted to the magnet. The magnet(s) may be selected to produce a strong enough force of magnetic attraction to retain the light module 20 in the base 10 against the force of gravity but also weak enough to allow a person to manually remove the light module 20 from the base 10 without significant difficulty and without the need for a tool.

The light assembly 1 of these examples may also include an electrical terminal 30 formed in a circle and an electrical terminal 40 to contact the electrical terminal 30 when the light module 20 is removably attached to the base 10 to conduct electricity from the base 10 to the light module 20. In the depicted examples, the electrical terminal 30 is positioned on the base 10 and the electrical terminal 40 is positioned on the light module 20, but it is also envisioned that the electrical terminal 30 is positioned on the light module 20 and the electrical terminal 40 is positioned on the base 10.

The depicted examples also show four each of the electrical terminal 30 and the electrical terminal 40, but it should be understood that any number of corresponding pairs of the electrical terminal 30 and the electrical terminal 40 may be provided depending on the requirements of the source of light 22 (e.g., one, two, three, four, or five pairs). As can be seen, the electrical terminals 30 are formed in concentric circles, each of the electrical terminals 30 having a different radius from the others as measured from a center point 2. Each of the corresponding electrical terminals 40 are located radially outwards from a center point 4 on the light module 20 that aligns with the center point of the base 10 when the light module 20 is removable attached to the base 10. As described above, the light module 20 may be freely rotatable 360° relative to the base 10 when removably attached thereto, and this arrangement allows for electrical communication between the base 10 and the light module 20 no matter their relative orientation. This may allow a person to easily attach the light module 20 without the need for precise alignment of the base 10 and the light module 20, which may be particularly difficult under a shelf or in a cabinet.

Each of the electrical terminals 30 has a contact surface 32 that is coplanar with the contact surface 32 of other electrical terminals 30. Each of the electrical terminals 40 may be a pogo pin that is biased (e.g., by a spring) to maintain contact with the corresponding electrical terminal 30 when the light module 20 is removably attached to the base 10 or rotated relative to the base 10. Also, the contact surface 32 of each of the electrical terminals 30 may be wider than a lateral dimension of the electrical terminals 40 to provide a tolerance for radial misalignment of the light module 20 relative to the base 10.

In a further alternative of the present technology, the base 10 may energize the light module 20 via electromagnetic induction. Thus, the base 10 may include an induction coil (i.e., a sender coil) instead of the electrical terminals 30 and the light module 20 may include an induction coil (i.e., a receiver coil) instead of the electrical terminals 40. Thus, the sender induction coil in the base 10 can be energized by electric current to generate an electromagnetic field, and the resonance in the receiver induction coil of the light module 20 due the electromagnetic field from the sender induction coil produces electric current to power the source of light 22.

The base 10 may include one or more electrical connectors 12 that can be connected to one or more corresponding electrical wires 14 to provide electricity to the light assembly 1 and to allow the light assembly 1 to pass electricity to additional light assemblies 1 in an installation. In the depicted examples, the electrical connector(s) 12 may be positioned on the base 10 such that the respective electrical wire(s) 14 extends from the base 10 in a radial direction when connected to the electrical connector 12. The base 10 also includes a recessed portion 18 for each of the electrical connectors 12, which permits the electrical connection between the electrical connectors 12 and the respective electrical wires 14 to be made below the top surface of the base 10 for a less intrusive installation whereby the electrical wires 14 do not interfere with the connection of the base 10 to structure to which it is mounted.

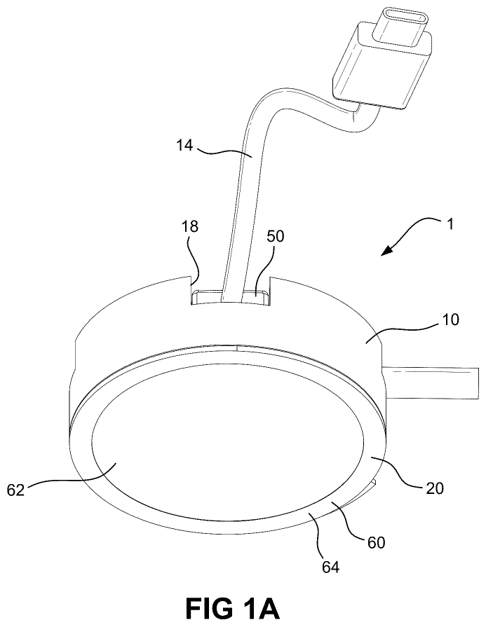

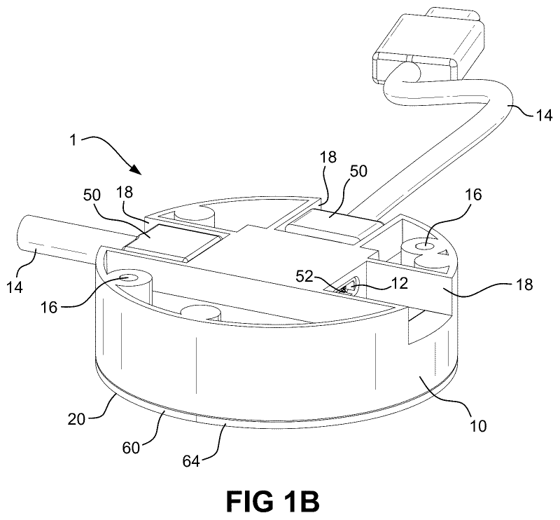

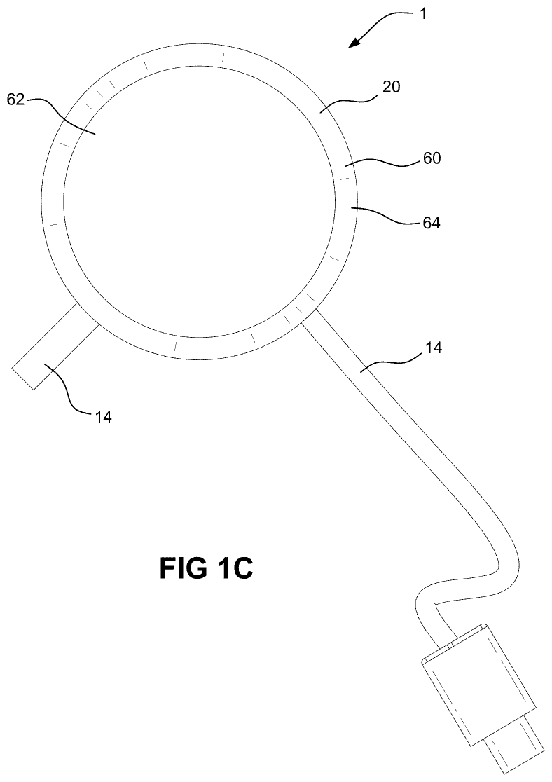

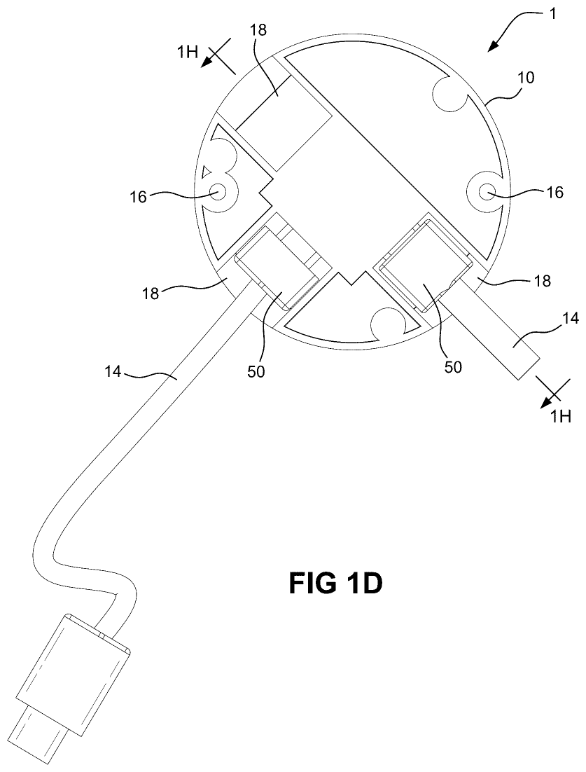

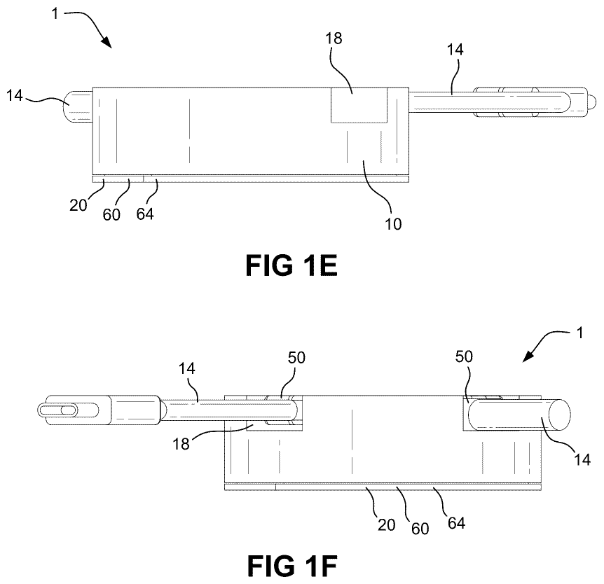

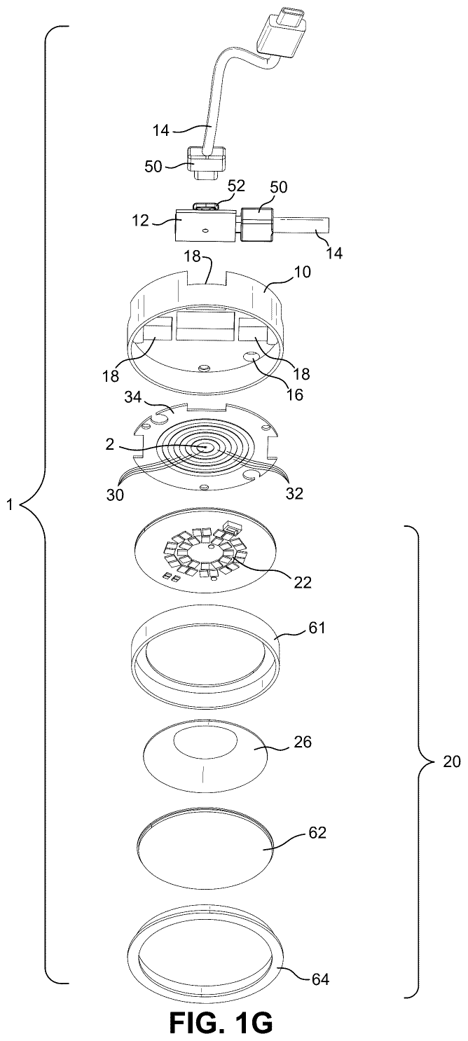

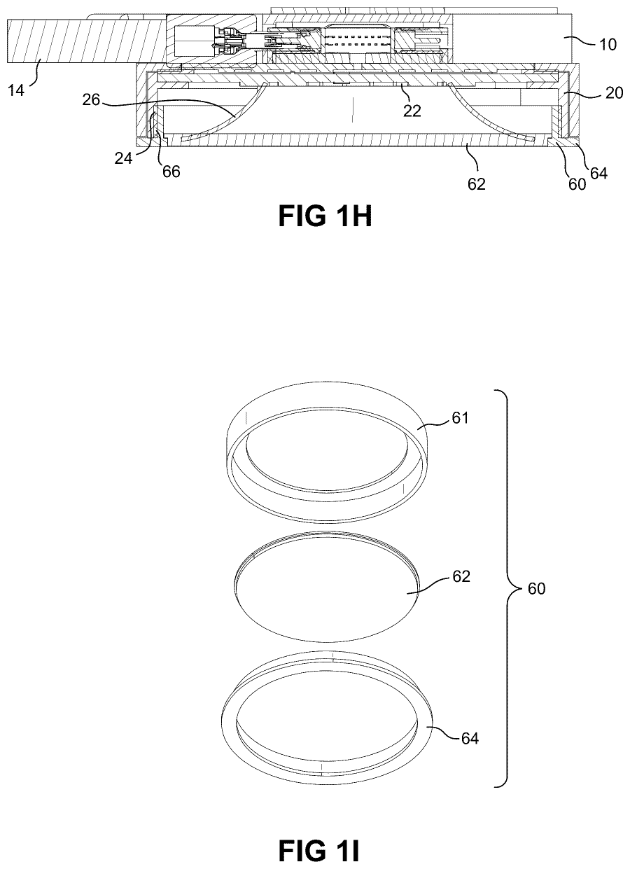

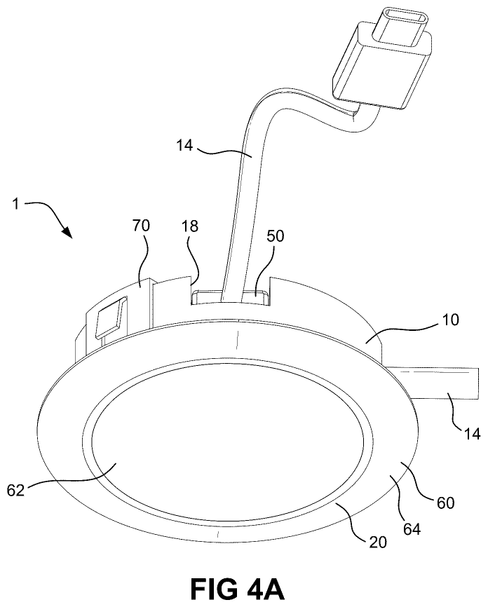

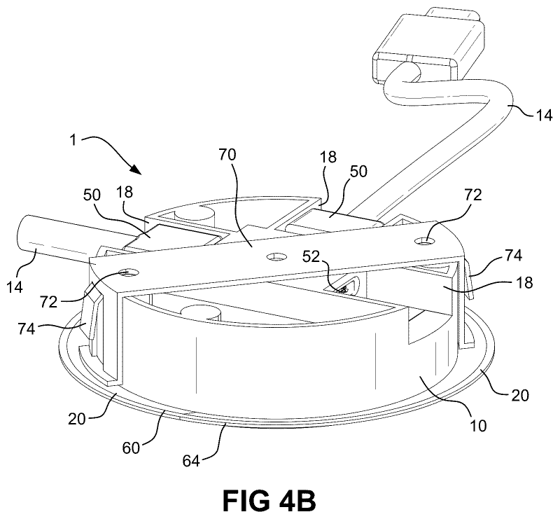

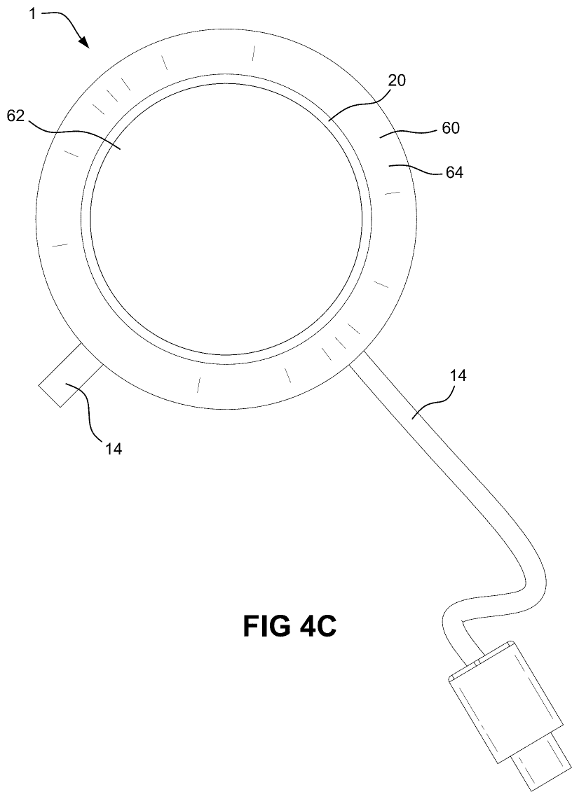

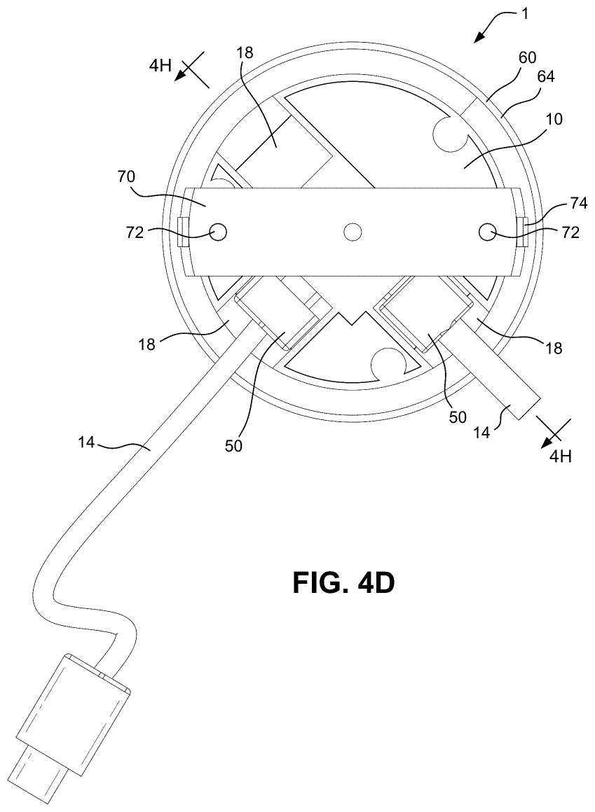

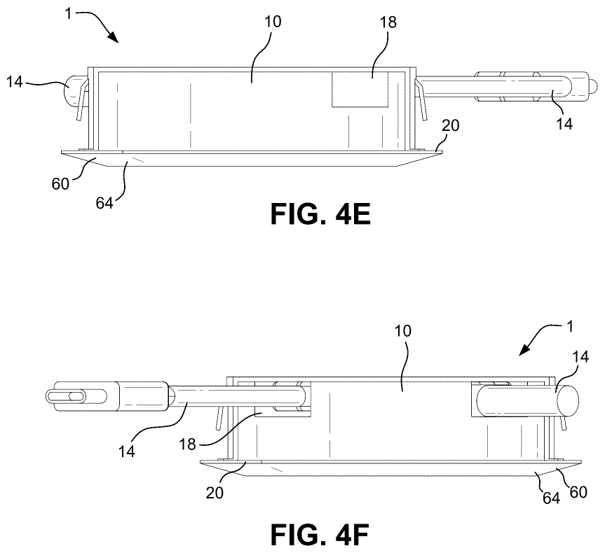

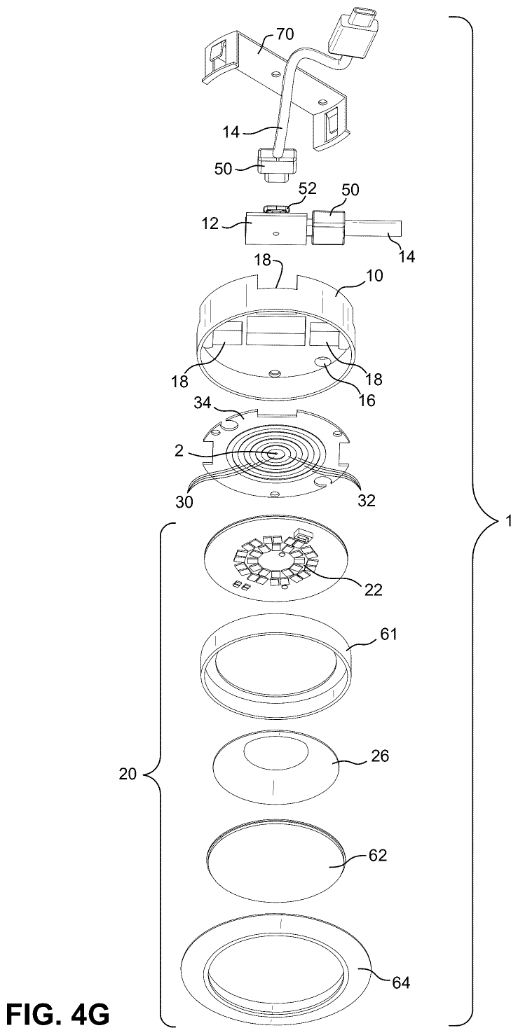

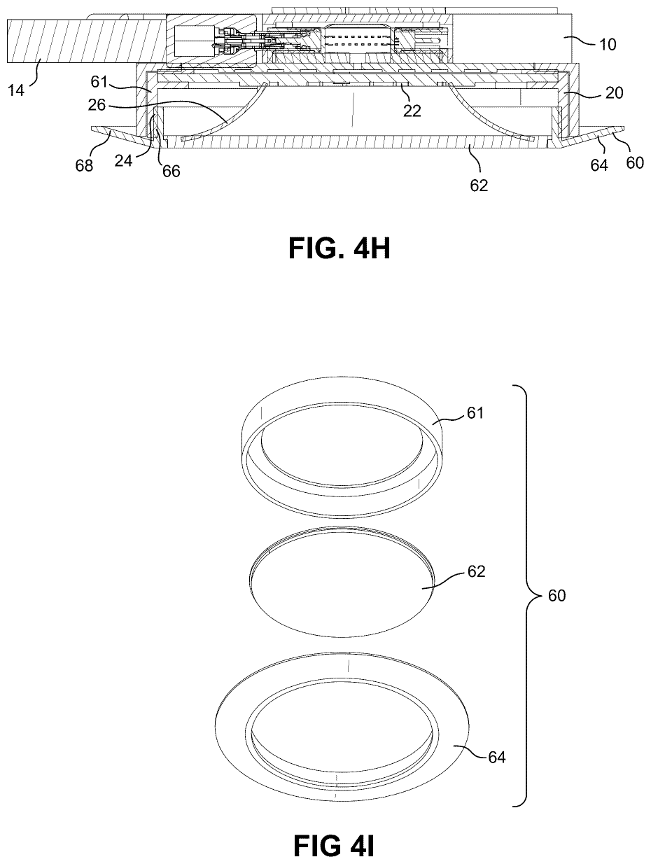

In the examples of FIGS. 1A-1H and 4A-4H, the electrical connectors 12 are in the form of USB-C connectors, in particular female USB-C connectors 52 that receive male USB-C connectors 50. In further variations, the male-female arrangement may be reversed.

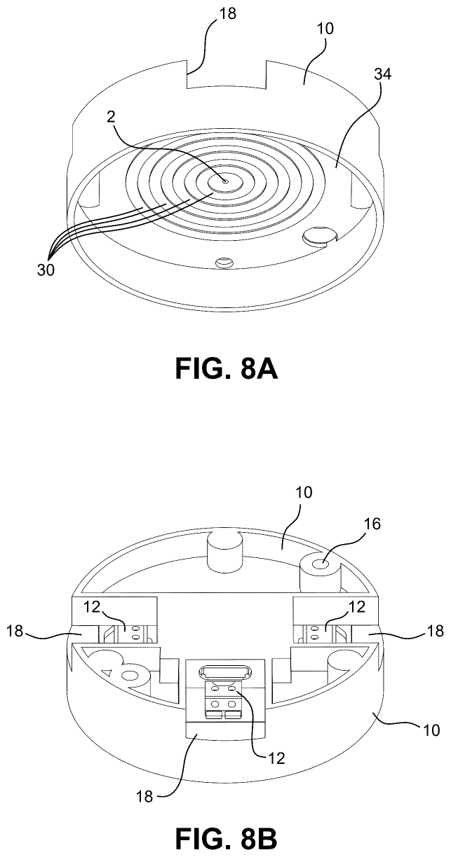

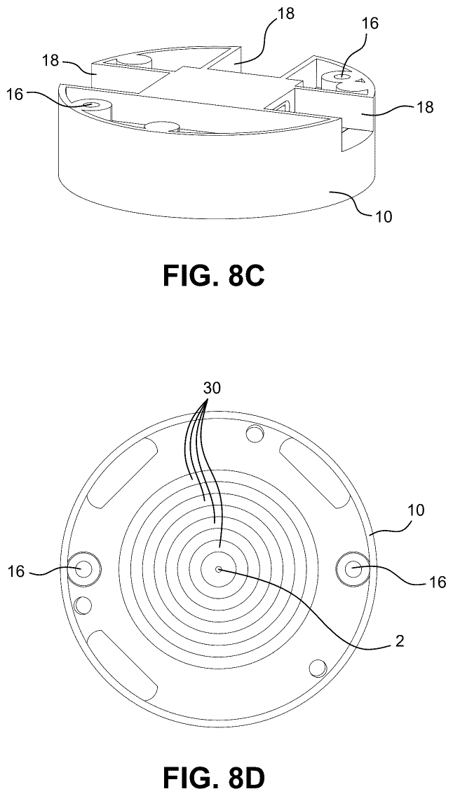

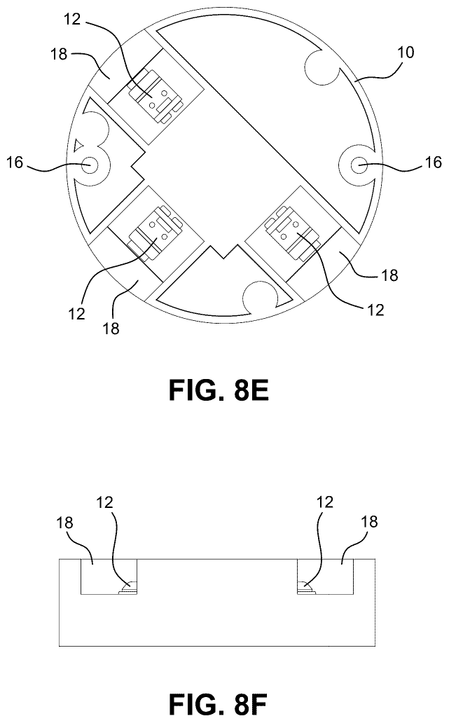

The base in FIGS. 8A-8F shows a further variation of the electrical connectors 12 in the form of wire splicing connectors, such as those made by WAGO GmbH & Co. KG. The wire splicing electrical connectors 12 in this example may be electrically connected to respective electrical wires 14 by push-in termination or lever actuation.

In the examples of FIGS. 1A-1H, 4A-4H, and 8A-8F, the base 10 includes three electrical connectors 12. One of electrical connectors 12 is connected to a source of electricity, which may be mains electricity or may be another light assembly 1 to form a sequential, series, or “daisy chain” arrangement. In other words, any given light assembly 1 may be capable of transmitting electricity to further light assemblies 1. In an installation of a group of light assemblies 1, the terminal light assembly 1 may be connected at only one of the electrical connectors 12 while intermediate light assemblies 1 receive electricity and distribute it to other light assemblies 1 to energize the array of light assemblies 1.

The light assembly 1 may also include a trim assembly 60, shown in FIGS. 1I and 4I, that may be removably attachable to a housing 61 of the light module 20. The trim assembly 60 may include a lens 62 that is positioned over the source of light 22 when the trim assembly 60 is removably attached to the light module 20, and a trim piece 64 may be positioned around the lens 62 to hold the lens 62 in position over the source of light 22. The lens 62 may be made of a transparent or translucent material and may be colored or clear.

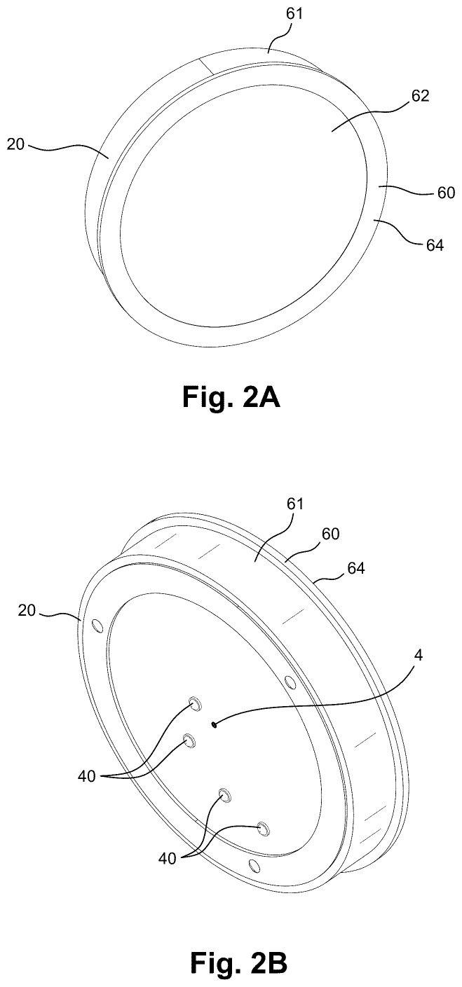

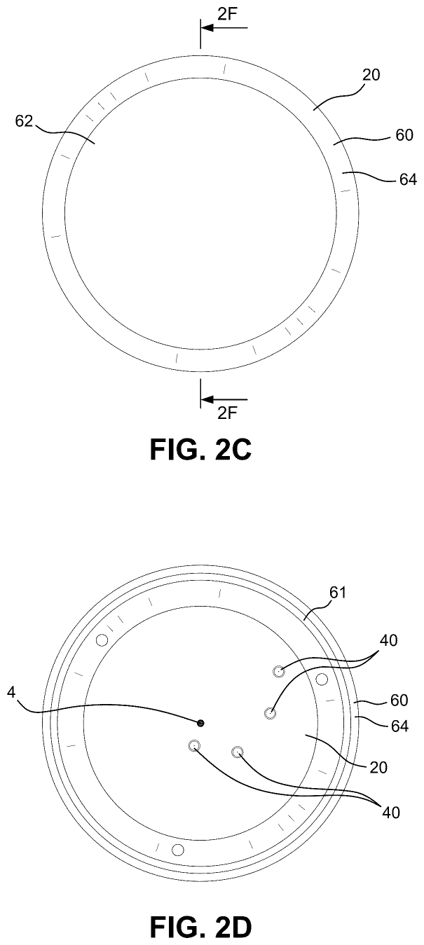

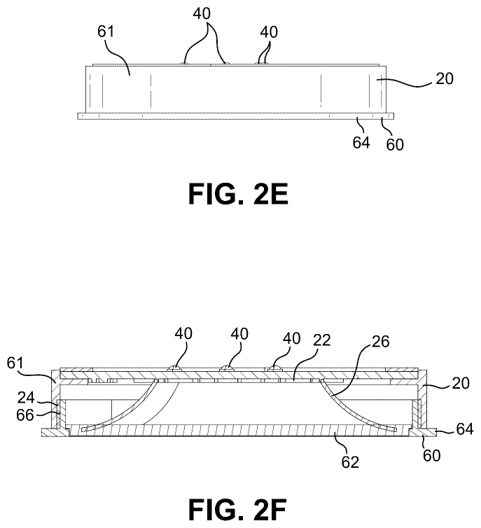

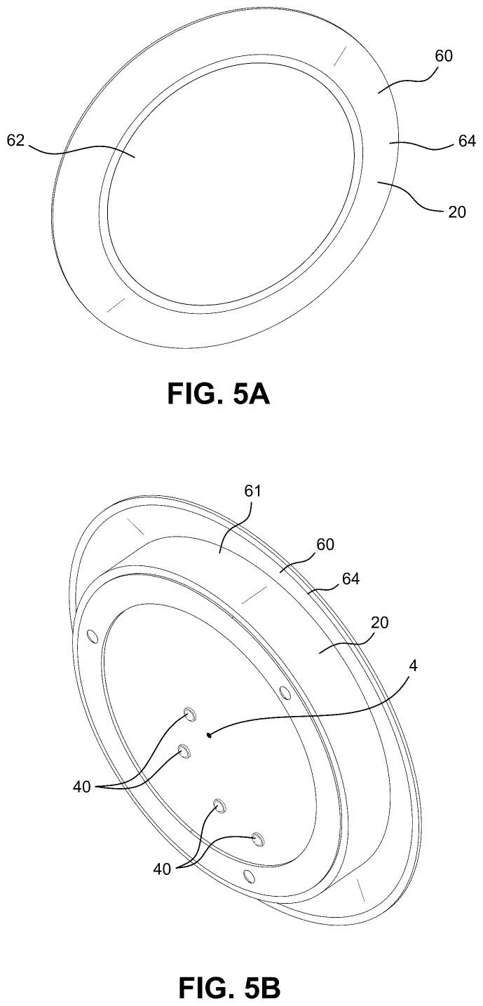

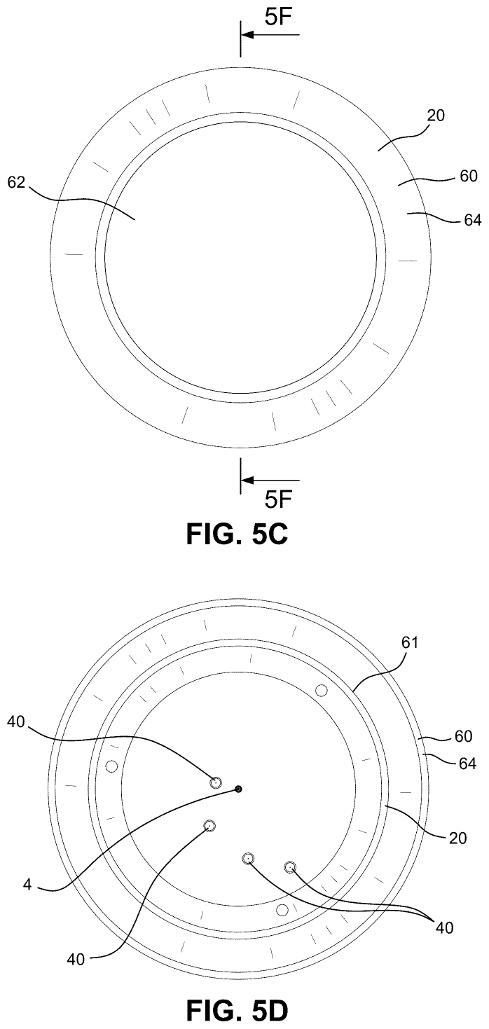

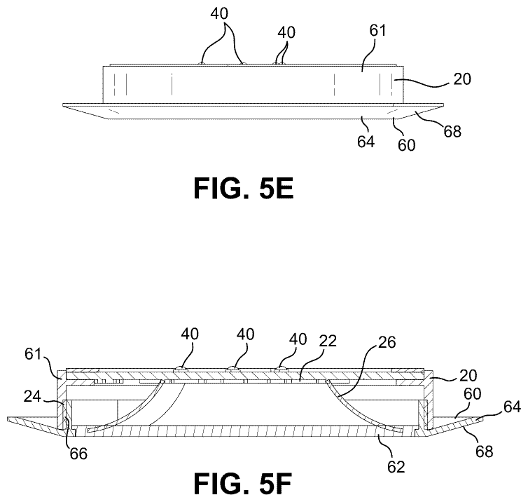

In the depicted examples (see FIGS. 1H, 2F, 4H, and 5F) the trim piece 64 includes threads 66 and the housing 61 of the light module 20 includes threads 24 that may be engaged to removably attach the housing 61 of the light module 20 to the trim piece 64. In a further alternative that is not shown, the trim piece 64 may be removably attached to the housing 61 of the light module 20 with a bayonet connection. In that variation, one of the trim piece 64 and the housing 61 of the light module 20 includes one or more ramped portions positioned around the circumference and the other of the trim piece 64 and the housing 61 of the light module 20 includes one or more protruding portions positioned around the circumference and corresponding to each of the ramped portions, the protruding portions engaging corresponding ones of the ramped portions to removably attach the housing 61 of the light module 20 to the trim piece 64.

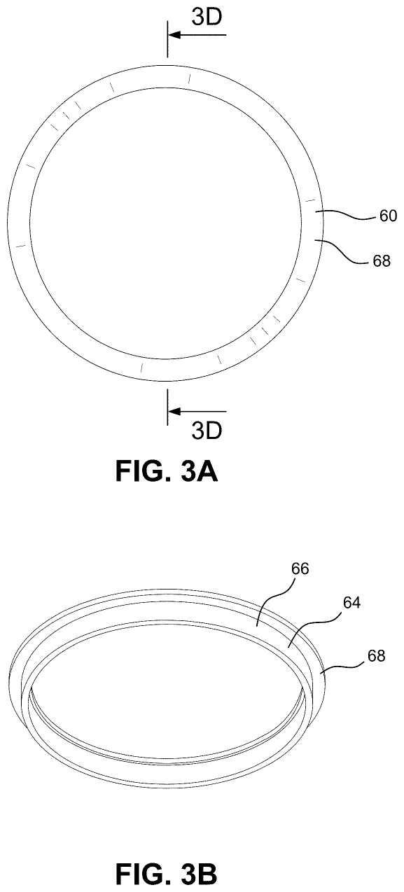

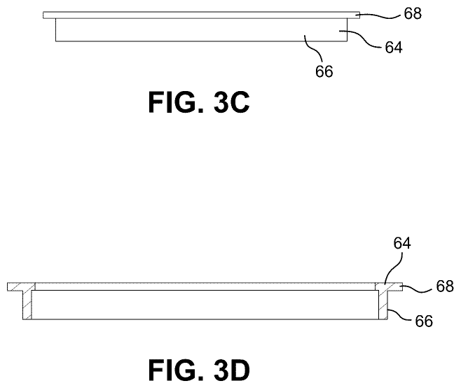

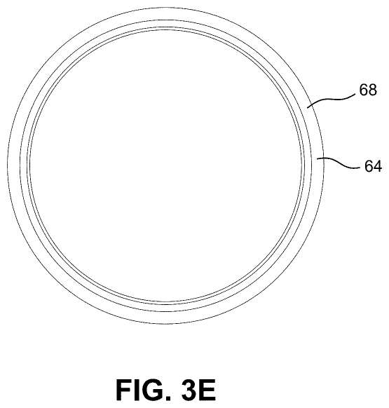

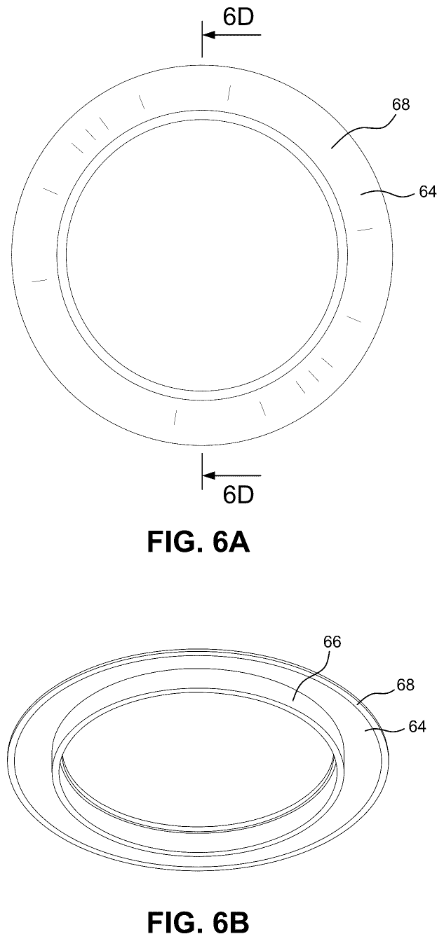

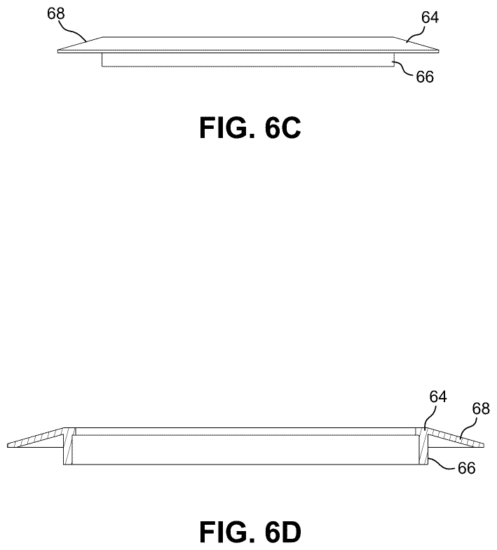

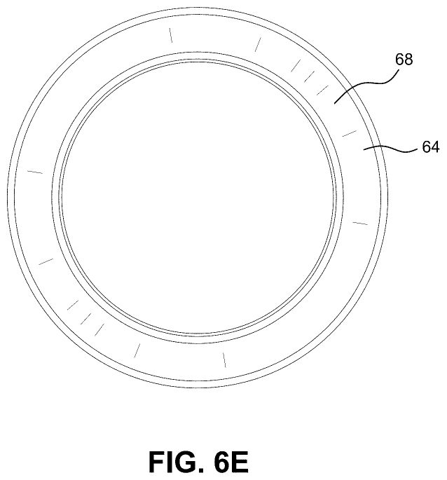

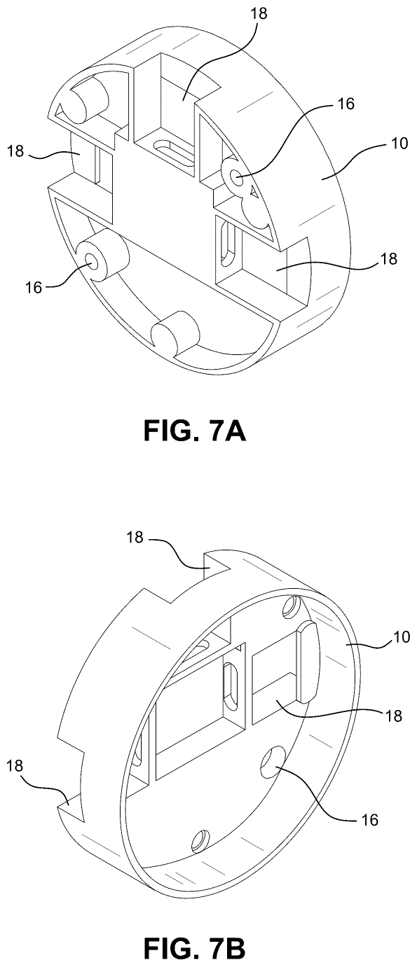

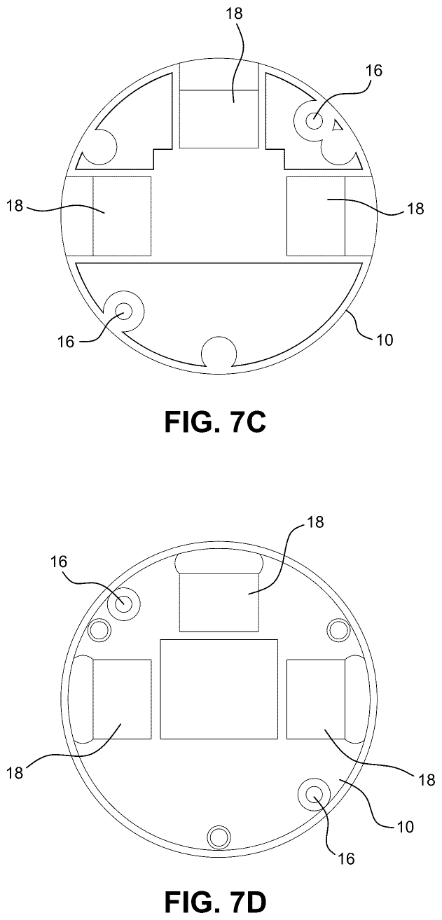

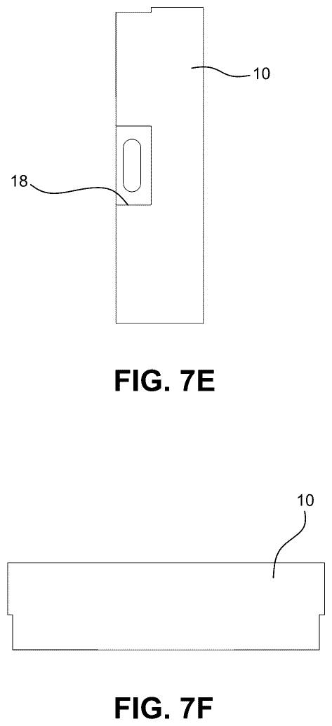

The trim piece 64 may include a lip 68 that extends radially outward around the trim piece 64. FIGS. 1A-3E show the trim piece 64 having a lip 68 in a flat, annular shape for surface-mount installations, i.e., where the top surface of the base 10 is mounted against a structure and the light assembly 1 extends downward therefrom. FIGS. 4A-6E show the trim piece 64 having a lip 68 that is frustoconical in shape for recessed installations, i.e., where most of the light assembly 1 is mounted inside of an opening of a structure and only the trim assembly 60 is exposed. In this variation, the sloped shape of the lip 68 may provide a clean aesthetic that flows into the structure against which it is flushly engaged.

The light assembly 1 may be attached to a structure directly via fastener(s) through one or more base holes 16 of the base 10 in the case of the aforementioned surface-mount installation. Alternatively, for the flush-mount installation also described above, a clip 70 having one or more clip holes 72 may be secured with fasteners to the base 10 at respective base holes 16. The clip 70 having one or more tangs 74 that engage the structure to which the light assembly 1 is mounted. In either arrangement, the base 10 may be fixed to the structure (e.g., shelf or cabinet) during installation in a permanent manner, but the removable attachment of the light module 20 allows that part to be readily replaced as needed.

While the technology has been described in connection with various examples of the technology, it is to be understood that the technology is not to be limited to the disclosed examples, but on the contrary, is intended to cover various modifications and equivalent arrangements included within the spirit and scope of the technology. Also, the various examples described above may be implemented in conjunction with other examples, e.g., aspects of one example may be combined with aspects of another example to realize yet other examples. Further, each independent feature or component of any given assembly may constitute an additional example.

### REFERENCE SIGNS LIST

| | |
|---|---|
| light assembly | 1 |
| center point | 2 |
| base | 10 |
| electrical connector | 12 |
| electrical wire | 14 |
| base hole | 16 |
| recessed portion | 18 |
| light module | 20 |
| source of light | 22 |
| threads | 24 |
| reflector | 26 |
| electrical terminal | 30 |
| contact surface | 32 |
| substrate | 34 |
| electrical terminal | 40 |
| male USB-C connector | 50 |
| female USB-C connector | 52 |
| trim assembly | 60 |
| housing | 61 |
| lens | 62 |
| trim piece | 64 |
| threads | 66 |
| lip | 68 |
| clip | 70 |
| clip hole | 72 |
| tang | 74 |

What is claimed is:

1. A light assembly comprising:
a base comprising a first electrical connector configured to be connected to a first electrical wire;
a light module removably attachable to the base and comprising a source of light;
a first electrical terminal positioned on the base or the light module and formed in a circle; and
a second electrical terminal positioned on the other of the base or the light module to contact the first electrical terminal when the light module is removably attached to the base.

2. The light assembly of claim 1, wherein the first electrical terminal is positioned on the base and the second electrical terminal is positioned on the light module.

3. The light assembly of claim 1, wherein the first electrical terminal is positioned on the light module and the second electrical terminal is positioned on the base.

4. The light assembly of claim 1, further comprising a plurality of first electrical terminals and a plurality of second electrical terminals,
wherein the plurality of first electrical terminals are formed in concentric circles, each of the first electrical terminals having a different radius from others of the first electrical terminals, and
wherein each of the second electrical terminals is positioned to contact a corresponding one of the first electrical terminals when the light module is removably attached to the base.

5. The light assembly of claim 4, wherein the plurality of first electrical terminals comprises two, three, or four first electrical terminals and the plurality of second electrical terminals comprises two, three, or four second electrical terminals, respectively.

6. The light assembly of claim 4, wherein each of the plurality of first electrical terminals has a contact surface that is coplanar with the contact surface of others of the plurality of first electrical terminals.

7. The light assembly of claim 1, wherein the second electrical terminal comprises a pogo pin that is biased to maintain contact with the first electrical terminal when the light module is removably attached to the base.

8. The light assembly of claim 1, wherein the light module is freely rotatable relative to the base when the light module is removably connected to the base.

9. The light assembly of claim 1, wherein the first electrical connector is a wire splicing connector configured to be electrically connected to the first electrical wire by push-in termination or lever actuation or the first electrical connector is a USB-C connector.

10. The light assembly of claim 1, wherein the first electrical connector is positioned on the base such that the first electrical wire extends from the base in a radial direction when connected to the first electrical connector.

11. The light assembly of claim 1, wherein the base comprises a second electrical connector configured to be connected to a second electrical wire.

12. The light assembly of claim 11, wherein the second electrical connector is a wire splicing connector configured to be electrically connected to the second electrical wire by push-in termination or lever actuation or the second electrical connector is a USB-C connector.

13. The light assembly of claim 11, wherein the second electrical connector is positioned on the base such that the second electrical wire extends from the base in a radial direction when connected to the second electrical connector.

14. The light assembly of claim 1, wherein the source of light is one or more light-emitting diodes (LEDs).

15. The light assembly of claim 1, wherein the base comprises a first magnet and the light module comprises a second magnet positioned and oriented on the light module to be magnetically attracted to the first magnet to removably attach the light module to the base.

16. The light assembly of claim 1, further comprising a trim assembly removably attachable to the light module, the trim assembly comprising a lens configured to be positioned over the source of light when the trim assembly is removably attached to the light module, and the trim assembly comprising a trim piece positioned around the lens.

17. The light assembly of claim 16, wherein the trim piece comprises first threads and the light module comprises second threads, the first threads and the second threads being configured to be engaged to removably attach the light module to the trim piece.

18. The light assembly of claim 16, wherein one of the trim piece and the light module comprises one or more ramped portions and the other of the trim piece and the light module comprises one or more protruding portions corresponding to each of the ramped portions and configured to be engaged to corresponding ones of the ramped portions to removably attach the light module to the trim piece.

19. The light assembly of claim 16, wherein the trim piece comprises a lip that extends radially outward around the trim piece.

20. The light assembly of claim 1, wherein the base comprises one or more base holes, each of the base holes being configured to receive a fastener.

21. The light assembly of claim 20, further comprising a clip having one or more clip holes that correspond to each of the base holes, the clip being configured to be secured to the base with the fastener at each pair of the base hole and the corresponding clip hole, the clip having one or more tangs.

22. The light assembly of claim 1, wherein the base comprises a recessed portion, the first electrical connector being positioned in the recessed portion.

23. The light assembly of claim 1, wherein one of the base and the light module includes a magnet and the other of the base and the light module includes a ferromagnetic material that is positioned and oriented to be attracted to the magnet to removably attach the light module to the base.

24. A light assembly comprising:
a base comprising a first electrical connector configured to be connected to a first electrical wire;
a light module removably attachable to the base and comprising a source of light;
a sender induction coil positioned on the base and configured to generate an electromagnetic field; and
a receiver induction coil positioned on the light module and configured to resonate in response to the electromagnetic field generated by the sender induction coil and produce electric current, when the light module is removably attached to the base and the sender induction coil is energized by electric current.

25. The light assembly of claim 24, wherein the light module is freely rotatable relative to the base when the light module is removably connected to the base.

26. The light assembly of claim 24, wherein the first electrical connector is a wire splicing connector configured to be electrically connected to the first electrical wire by push-in termination or lever actuation or the first electrical connector is a USB-C connector.

27. The light assembly of claim 24, wherein the first electrical connector is positioned on the base such that the first electrical wire extends from the base in a radial direction when connected to the first electrical connector.

28. The light assembly of claim 24, wherein the base comprises a second electrical connector configured to be connected to a second electrical wire.

29. The light assembly of claim 28, wherein the second electrical connector is a wire splicing connector configured to be electrically connected to the second electrical wire by push-in termination or lever actuation or the second electrical connector is a USB-C connector.

30. The light assembly of claim 28, wherein the second electrical connector is positioned on the base such that the second electrical wire extends from the base in a radial direction when connected to the second electrical connector.

31. The light assembly of claim 24, wherein the source of light is one or more light-emitting diodes (LEDs).

32. The light assembly of claim 24, wherein the base comprises a first magnet and the light module comprises a second magnet positioned and oriented on the light module to be magnetically attracted to the first magnet to removably attach the light module to the base.

33. The light assembly of claim 24, further comprising a trim assembly removably attachable to the light module, the trim assembly comprising a lens configured to be positioned over the source of light when the trim assembly is removably attached to the light module, and the trim assembly comprising a trim piece positioned around the lens.

34. The light assembly of claim 33, wherein the trim piece comprises first threads and the light module comprises second threads, the first threads and the second threads being configured to be engaged to removably attach the light module to the trim piece.

35. The light assembly of claim 33, wherein one of the trim piece and the light module comprises one or more ramped portions and the other of the trim piece and the light module comprises one or more protruding portions corresponding to each of the ramped portions and configured to be engaged to corresponding ones of the ramped portions to removably attach the light module to the trim piece.

36. The light assembly of claim 33, wherein the trim piece comprises a lip that extends radially outward around the trim piece.

37. The light assembly of claim 24, wherein the base comprises one or more base holes, each of the base holes being configured to receive a fastener.

38. The light assembly of claim 37, further comprising a clip having one or more clip holes that correspond to each of the base holes, the clip being configured to be secured to the base with the fastener at each pair of the base hole and the corresponding clip hole, the clip having one or more tangs.

39. The light assembly of claim 24, wherein the base comprises a recessed portion, the first electrical connector being positioned in the recessed portion.

40. The light assembly of claim 24, wherein one of the base and the light module includes a magnet and the other of the base and the light module includes a ferromagnetic material that is positioned and oriented to be attracted to the magnet to removably attach the light module to the base.
